(19) United States
(12) Patent Application Publication
(10) Pub. No.: US 2010/0304663 A1
(43) Pub. Date: Dec. 2, 2010

(54) Time-varying indirect service authorization method and apparatus

(75) Inventors: Richard Andrew Michalski, Coral Springs, FL (US); Jeffrey Eric Malinsky, Fort Lauderdale, FL (US); Mark Rindsberg, Boca Raton, FL (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: Sirius XM Radio inc., New York, NY (US)

(21) Appl. No.: 12/799,896

(22) Filed: May 3, 2010

Related U.S. Application Data
(60) Provisional application No. 61/174,956, filed on May 1, 2009.

(51) Int. Cl. H04H 20/74

(52) U.S. Cl. 455/3.02

(57) ABSTRACT

Apparatus and methods for providing both commercial-free content and commercially sponsored content in a flexible manner to various subscriber classes of digital audio radio are presented. In exemplary embodiments of the present invention, lower tier subscribers can, for example, sample commercial free content as experienced by higher tier subscribers by means of flexible channel authorization. In exemplary embodiments of the present invention new non-subscribers can be allowed to sample some of the commercial content (such as, when, for example, a default UPC is stored in the radio before shipment) before choosing to subscribe. In exemplary embodiments of the present invention, a digital audio radio (receiver) can include a controller operable to receive and store an Uplink Package Code (UPC) in the digital audio radio. The radio can be further operable to receive, for example, a broadcast Package Definition Message (PDM) that maps the stored UPC to a list of authorized channels (obtained via a broadcast Package Authorization List (PAL)) for that receiver. In exemplary embodiments of the present invention, a method of channel authorization for digital audio radios can include assigning an Uplink Package Code (UPC) to, and storing the UPC in, a digital audio radio and receiving a broadcast Package Definition Message (PDM) that maps the UPC to a list of authorized channels (from a Package Authorization List (PAL)).

### CROSS-REFERENCE TO RELATED APPLICATIONS

This application claims priority to U.S. Provisional Patent Application No. 61/174,956, filed on May 1, 2009, which is hereby incorporated herein by reference.

### FIELD OF THE INVENTION

The invention relates generally to systems and methods of providing channel authorizations for a broadcast subscription service of a plurality of channels, and more particularly for various indirect and flexible methods of channel authorization.

### BACKGROUND OF THE INVENTION

Digital satellite radio, such as, for example, those services provided by Sirius XM Satellite Radio Inc. currently offers well over a hundred channels of content over a large geographic footprint. Offering channels with varying content (commercial free content versus content with commercials) to different subscribers based on a subscription level can be difficult in a system that broadcasts a digital stream of content. Although there are schemes to provide a mix of content to various users, such as between commercial-free and commercial or sponsored programming, none appear to provide sufficient flexibility in a commercially reasonable manner (without wasting substantial amounts of the available bandwidth).

What is thus needed in the art are methods of conveniently differentially and variably authorizing content to subscribers of a broadcast service.

### SUMMARY OF THE INVENTION

In exemplary embodiments of the present invention, both commercial-free content and commercially sponsored content can be provided in a flexible manner to different classes of subscribers of digital audio radio, such as, for example, subscribers to a Satellite Digital Audio Radio Service (“SDARS”), such as those offered by, for example, Sirius XM Radio Inc. In exemplary embodiments of the present invention, lower tier subscribers can, for example, sample commercial free content as experienced by higher tier subscribers by means of flexible channel authorization. In exemplary embodiments of the present invention new non-subscribers can be allowed to sample some of the commercial content (such as, when, for example, a default UPC is stored in the radio before shipment) before choosing to subscribe.

In exemplary embodiments of the present invention, a digital audio radio (receiver) can include a controller operable to receive and store an Uplink Package Code (UPC) in the digital audio radio. The radio can be further operable to receive, for example, a broadcast Package Definition Message (PDM) that maps the stored UPC to a list of authorized channels (obtained via a broadcast Package Authorization List (PAL)) for that receiver.

In exemplary embodiments of the present invention, a method of channel authorization for digital audio radios can include assigning an Uplink Package Code (UPC) to, and storing the UPC in, a digital audio radio and receiving a broadcast Package Definition Message (PDM) that maps the UPC to a list of authorized channels (from a Package Authorization List (PAL)).

### BRIEF DESCRIPTION OF THE DRAWINGS

FIG. 1 is a timing diagram illustrating a commercial free period and a commercial insertion period according to an exemplary embodiment of the present invention;

FIG. 2 is an illustration showing a Broadcast Authorization Channel and its association to authorizing channels using a Package Definition Message that relates a PAL to a UPC according to an exemplary embodiment of the present invention;

FIGS. 2A and 2B are expanded versions of the left and right portions of FIG. 2 respectively;

FIG. 3 is an illustration of a Service Authorization Message (SAM) according to an exemplary embodiment of the present invention;

FIG. 4 is an illustration of Package Definition Message (PDM) according to an exemplary embodiment of the present invention;

FIG. 5 is an illustration of a radio conditional access memory containing both an Ante-Expiry PAL and a Post-Expiry PAL according to an exemplary embodiment of the present invention;

FIG. 6 is a timing diagram illustrating how commercially sponsored package would be authorized during a commercial free period and a commercial insertion period according to an exemplary embodiment of the present invention; and

FIGS. 7-18 illustrate in detail various aspects of exemplary use cases according to various exemplary embodiments of the present invention.

It is noted that the patent or application file may contain at least one drawing executed in color. If that is the case, copies of this patent or patent application publication with color drawing(s) will be provided by the U.S. Patent and Trademark Office upon request and payment of the necessary fee.

### DETAILED DESCRIPTION OF THE INVENTION

Satellite radio operators, such as for example, Sirius XM Radio Inc., provide digital radio broadcast services covering the entire continental United States, portions of Canada, and hope to expand such coverage to other areas of the Americas. These services offer approximately 100 channels or more, of which nearly 50 channels in a typical configuration provides music with the remaining stations offering news, sports, talk and data channels. Briefly, the service provided by Sirius XM Radio includes a satellite X-band uplink to two satellites which provide frequency translation to the S-band for re-transmission to radio receivers on earth within a coverage area. Radio frequency carriers from one of the satellites can also be received by terrestrial repeaters. The content received at the repeaters is retransmitted at a different S-band carrier to the same radios that are within their respective coverage areas. These terrestrial repeaters facilitate reliable reception in geographic areas where Geosynchronous Satellite reception is obscured by tall buildings, hills or other natural obstructions, tunnels, or other obstructions. The signals transmitted by the satellites and the repeaters are received by satellite digital audio radio system (SDARS) receivers which can be located in automobiles, in handheld or in stationary units for home or office use. The SDARS receivers are designed to receive one or both of the satellite signals and the signals from the terrestrial repeaters and combine or select one of the signals as the receiver output.

Each SDARS receiver contains a unique Hardware Identification number (HWID), which is assigned during the manufacturing process and is used by SDARS service providers to enable or disable the radio to receive subscribed services, such as music and talk programming. In addition, these subscribed services could include data services, such as weather and traffic data feeds or other custom data feeds. The custom data feeds are typically uniquely enabled by an SDARS service provider for select subscriber groups.

It is most useful for such broadcasters to change subscriber authorizations as to channel packages with time. This allows, for example, allowing all subscribers, or every tier, to sample new channels or participate in “free weekend” promotions, or to upgrade their subscription with relative ease. One approach for providing a mix of commercial free channels and commercial sponsor channels is a “free to air” option where some set of channels have commercials and do not require authorization. This option would provide a solution to all legacy (i.e., existing) radios with no changes to either uplink (signaling) or to the radios. Unfortunately, however, this scheme would force even paying subscribers to listen to commercials on these channels (and thus the SDARS provider could not claim that its music service is “100% commercial free”). Additionally, Free to Air (FTA) channels have restrictions as regards where they are placed within the broadcast service.

Another possible approach entails a stored commercial option where radios have stored commercial content that gets inserted into certain channels. In this solution, paying subscribers do not need to listen to the commercials. However, this approach requires a major modification to hardware and software resources so as to handle the commercial storage and insertion features, which would increase the cost of radios. The stored commercial option would also (i) require an additional channel to carry commercial content, (ii) add additional complexity associated with a timing mechanism to force insertion of commercials and (iii) might expose the radios to a risk of hacking (removal of memory, etc.) in the event that unscrupulous users attempt to defeat the commercial insertion mechanisms. Thus, this approach is generally too complex and expensive, and thus inelegant. Furthermore, such a commercial insertion would not be “seamless.”

Instead, in exemplary embodiments of the present invention a Rotating Package Definition (“RPD”) can be used, whereby radios have a stored Uplink Package Code (UPC) that is periodically redefined to remove access to “regular” channels and add access to one or more “commercial” channel(s). With such a Rotating Package Definition, paying subscribers with basic packages do not need to listen to commercials, and no additional memory is required in the radio. Such a system is also supported by current hardware and generally supported by existing uplink.

Thus, in exemplary embodiments of the present invention, a Rotating Package Definition enables flexibility in choosing which channels are included in the commercially sponsored package(s) and further provides a good match for original equipment manufacturer (“OEM”) use (for example, PE-UPC could be set to a commercial sponsored package at time of Factory Activation). In exemplary embodiments of the present invention a Rotating Package Definition solution can, for example, (i) modify the uplink to automate changes to PDM, (ii) include new radio software to buffer the previously selected two channels and then tune to only authorized encrypted content instead of the free-to-air preview channel when authorization for a channel is removed, and (iii) return to a last tuned channel when authorization for that channel returns. Although using this solution may not always have commercial insertion that is “seamless”, several techniques can be used to smooth out transitions between commercial free content periods and commercial insertion periods as described below.

In exemplary embodiments of the present invention a Rotating Package Definition solution can be implemented in a number of ways. First, for example, an Indirect Authorization Method can indirectly authorize radios to receive service by first being assigned an Uplink Package Code (UPC), which is stored in the radio (as opposed to obtaining a specific key or token which directly authorizes the radio for a particular level of service or number of services). The uplink package code (UPC) can then be used, for example, to match a second secure message (for example, a broadcast message called the Package Definition Message (PDM)) that maps the UPC to a list of authorized channels for that receiver. Second, this authorization can be periodically varied. Thus, rather than having a fixed association or quasi-fixed association between the UPC and a set of services authorized by that package code, the uplink now has a method of periodically varying the association. By periodically varying the Package Definition Message for a particular UPC, subscribers which have that UPC stored in their radio will have their authorizations vary without the need for the SDARS service provider to individually address their radios.

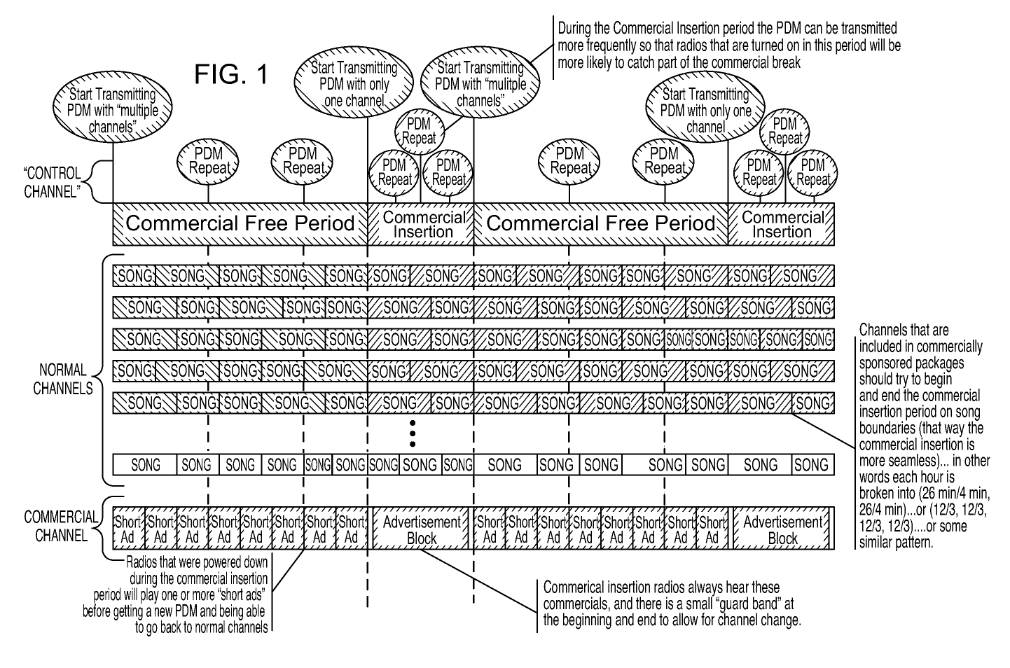

Referring now to FIG. 1, in exemplary embodiments of the present invention a control channel or Broadcast Authorization Channel can, for example, transmit a Package Definition Message (PDM) that authorizes a receiver to listen to multiple channels during a commercial free period. For radios that are commercially sponsored (i.e., radios that receive programming with commercial messages interspersed, based on subscriber tier), a PDM can be, for example, repeatedly transmitted during a Commercial Insertion Period that only authorizes listening to a single channel that contains a commercial or commercials. As seen at the top bar of FIG. 1, The PDMs being repeatedly transmitted can be changed, for example, based on the period (i.e., Commercial Free Period or Commercial Insertion Period) in which they are transmitted. In exemplary embodiments of the present invention, commercial insertion radios can have a “guard band” at each of the beginning and end of a Commercial Insertion Period so as to allow for a smoother channel change transition. Channels that are included in commercially sponsored packages can, in general, try to begin and end their respective commercial free periods on song boundaries so that the commercial insertion will appear more seamless. To facilitate this, for example, a particular ratio of songs and commercials can be adhered to in a repeated pattern.

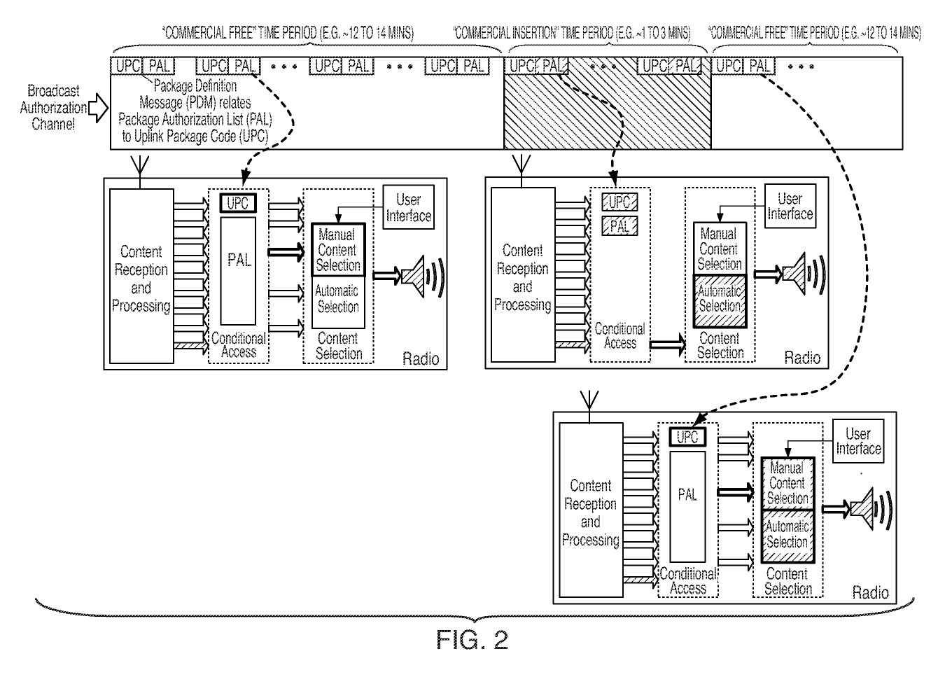

Turning now to FIG. 2, a more detailed illustration of the PDM and its relationship to the Package Authorization List (PAL) and the Uplink Package Code (UPC) are shown. As seen at the top of FIG. 2, an exemplary Broadcast Authorization channel transmits a series of Package Definition Messages throughout each of the “commercial free” and the “commercial insertion” time periods. Each PDM associates a given UPC to a given PAL. Thus, a receiving radio updates the PAL if the UPC in the PDM matches a UPC stored in that radio. During the Commercial Free Period, the uplink transmits a PDM that maps the UPC for a sponsored package (i.e., a subscription package having commercials) to a PAL that includes a plurality of channels and subscribers of that sponsored package are free to listen to any of the authorized channels. In other words, subscribers are free to select and tune to any one of the many authorized channels during the Commercial Free Period. The authorized set of channels can be, for example, all, or, for example, some subset of, the total set of channels in the broadcast service. Thus, the PAL filters the authorized set of channels for any given receiver.

However, during a Commercial Insertion Period, the uplink transmits a PDM that maps the UPC for a sponsored package to a PAL that includes only a single channel—the channel that has commercial messages. During the Commercial Insertion Period, all subscribers to the sponsored (or subsidized) package listen to the same content (i.e., one or more commercial messages).

In exemplary embodiments of the present invention a Commercial Free Period can be, for example, ˜12 to ˜14 minutes long, and a Commercial Insertion Period can be, for example, ˜1 to ˜3 minutes long. Other exemplary embodiments can vary these lengths and relative length rations as may be desired or acceptable in a given market. Channels that are included in commercially sponsored packages can, for example, try to begin and end the commercial insertion period on song boundaries (that way the commercial insertion is more seamless). For example, as shown in FIG. 2, each hour can be broken up into (26 min/4 min, 26/4 min), (12/3, 12/3, 12/3, 12/3), or some similar pattern.

It is noted that for ease of viewing, FIGS. 2A and 2B are each magnified portions of FIG. 2, being the left and right sides, respectively.

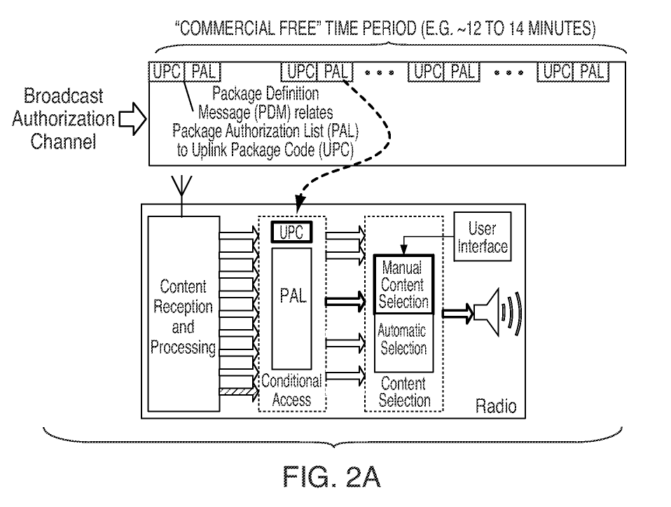

Turning now to FIG. 3, an exemplary Service Authorization Message (SAM) is shown. In exemplary embodiments of the present invention, an SAM can be used to assign one or more UPCs to a given radio. In the depicted example, two UPCs each having an expiration date are provided, so as to control when the first expires and when the second becomes active. In general, an assignment message can, for example, assign multiple UPCs to the radio with a start and an end validity for each one.

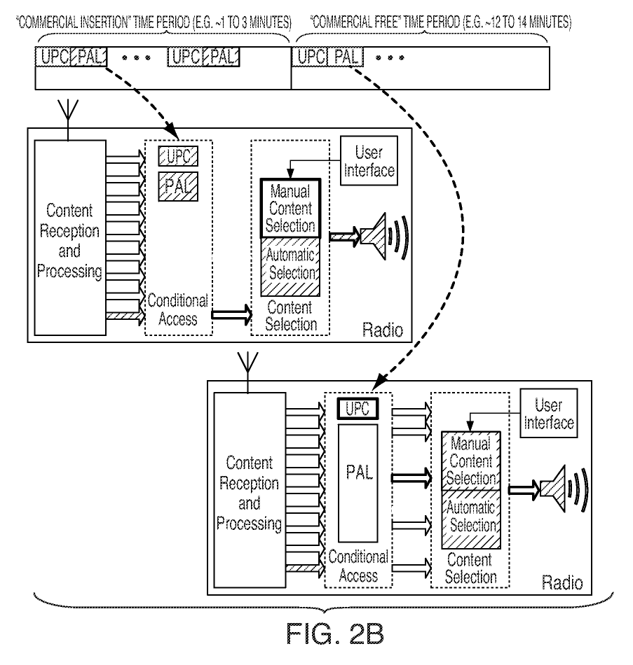

FIG. 4 illustrates a PDM which defines the list of services that anyone having that given package should be able to receive. Such services are known as a Package Authorization List (“PAL”).

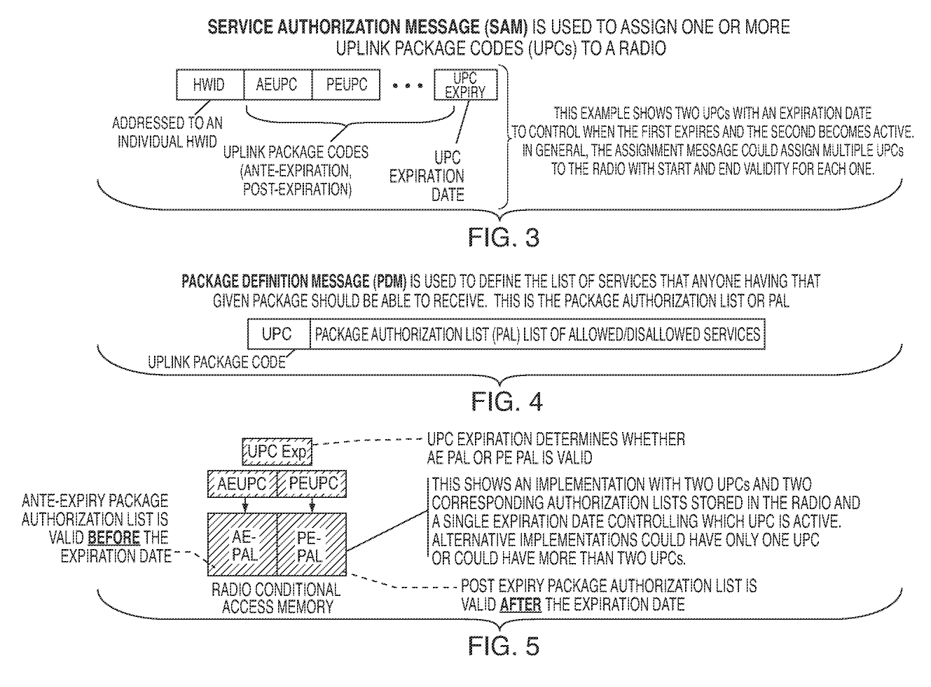

FIG. 5 depicts an exemplary Radio Conditional Access Memory. In the depicted implementation there are two UPCs assigned to the radio, and two corresponding authorization lists are stored in the radio. The two UPCs can be assigned to the radio via a SAM as depicted in FIG. 3, described above. With reference to FIG. 5, in exemplary embodiments of the present invention, a single expiration date can control, for example, which UPC is active. Until the expiration date, the Ante-Expiry UPC (“AE-UPC”) is valid, and thus the receiver can play any channel in the Ante-Expiration PAL (“AE-PAL”). After the expiration date, only the Post-Expiry UPC (“PE-UPC”) is valid, and thus only those channels in the Post-Expiry PAL (“PE-PAL”) are valid on that receiver. In alternate exemplary embodiments of the present invention, an implementation can have only one UPC or, for example, can have even more than two UPCs to implement similar flexible PAL controls.

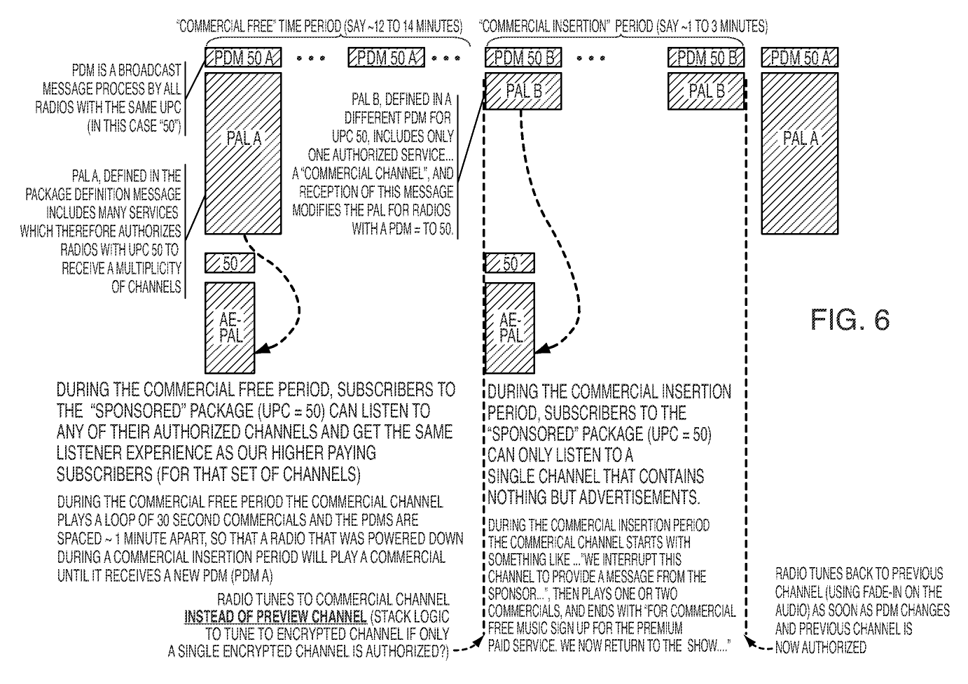

FIG. 6 illustrates another time line where a specific sponsored package (UPC 50) enables listening to any of the authorized channels during a commercial free period and tunes to a single channel during the commercial insertion period, as described above. The radio tunes back to a previous channel as soon as the PDM changes. It is recalled that a PDM associates a given UPC to a given PAL, as described in connection with FIG. 4.

Given the exemplary functionalities according to exemplary embodiments of the present invention, various real-world exemplary use cases can be envisioned. In a first use case, a simple method of enabling “Teaser” or “free trial” channels for specific populations of subscribers can be implemented by temporarily varying a PDM (for a period of, for example, a few days or a few weeks) to add additional channels to a given radio's PAL. In this manner, subscribers can be allowed to sample more channels than they would ordinarily be authorized to receive, and thus perhaps be enticed to upgrade their subscription to a higher tier, or to add specified premium content, for example.

In a second use case, essentially that depicted in FIGS. 2 and 6, certain commercially sponsored subscriber packages can have, for a certain set of packages (i.e., a range of UPCs), a variable Package Definition Message. Such a PDM can, for example, vary on a periodic or semi-periodic basis such that during some periods a multiplicity of channels are authorized (the “commercial free period”) and during other periods only a single channel is authorized (the “commercial insertion period”). In this way a lower subscription price could be offset by forcing all subscribers to this commercially sponsored package to listen to periodic commercials, while subscribers with higher-tier packages are not made to have to listen to commercials.

In a third use case, a variation on the second use case involving “targeted commercials” to a particular demographic or interest group, multiple different commercially sponsored packages having unique UPCs associated with different groups of subscribers (such as, for example, sports enthusiasts, music aficionados, people interested in lifestyle programming, or religiously affiliated individuals) can, for example, be created where various Package Definition Messages can vary on a periodic or semi-periodic basis such that during some periods a multiplicity of channels is authorized for each targeted group (the “commercial free period”) and during other periods only a single unique channel per commercially sponsored package is authorized (the “targeted commercial insertion period”). In this way a targeted group of subscribers with a lower subscription price, having a common UPC and common demographic or other affiliation, can, for example, be guided (forced, actually) to listen to periodic targeted commercials for that group, while subscribers with higher-tier packages do not have to listen to any commercials. In addition, for advertisers paying a higher fee, at certain times all of the targeted groups can be guided to listen to the same commercial by authorizing all UPCs for commercially sponsored packages to only receive the same commercial channel.

In a fourth use case, radios can, for example, be automatically moved from one UPC to another. In this case, a radio can be configured at the time of initial authorization (which can be, for example, at a factory or, for example, over-the-air) with two UPCs instead of one, such that the first UPC (the Ante-Expiry UPC) is valid for a fixed period of time after which the second UPC (the Post-Expiry UPC) becomes valid, as described in connection with FIG. 5. This exemplary use case can, for example, be combined with the second exemplary use case such that a radio can be authorized for a commercial free trial period after which the radio can automatically move to a commercially-sponsored package.

In yet another exemplary embodiment of the present invention, a radio, at the time of authorization (either over the air or during the manufacturing process), in addition to receiving and storing the UPC or UPCs assigned to the radio, can also, for example, receive an explicit list of services or an “a la carte” selection of services, which is then stored in the radio. This Service Authorization List (or SAL) gives the radio access to a list of channels in addition to the list authorized by the UPC (or UPCs, where multiple UPCs are provided), such that (i) when the subscriber listens to a channel that is authorized via the SAL the subscriber can avoid commercials, while (ii) when the subscriber listens to a channel authorized through the UPC, the subscriber is forced to listen to commercials because of the rotating package definition message, as described above. The SAL can have an explicit expiration date, leaving the radio only authorized for channels in the PAL afterwards. Alternatively, the UPC can have an explicit expiration date, while the SAL does not expire, thus allowing, for example, a limited period of access to a large number of commercial sponsored channels, followed by a permanent ability to receive only the channels that were specifically selected at the time of authorization (the “a la carte” channel selection).

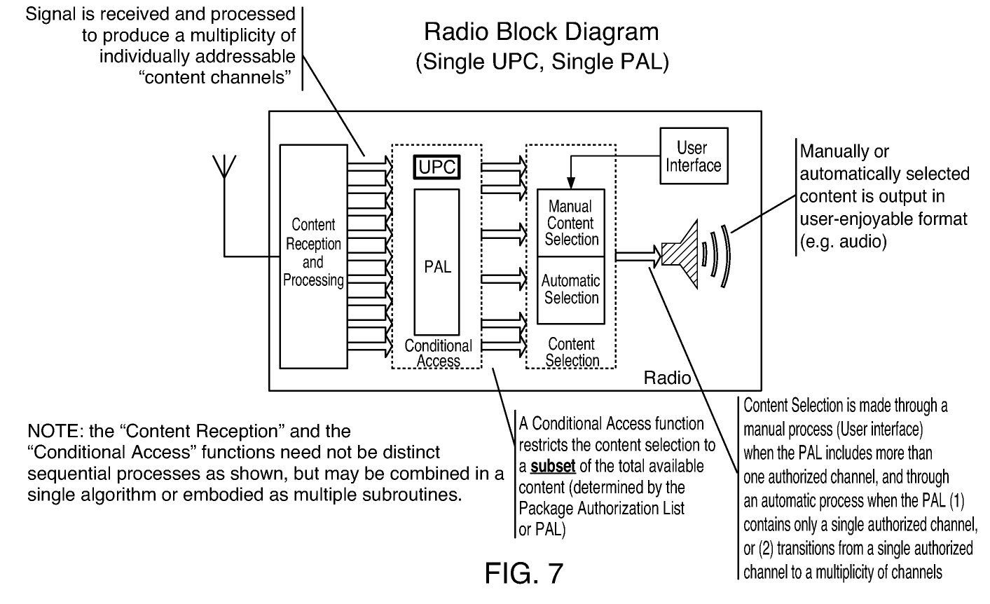

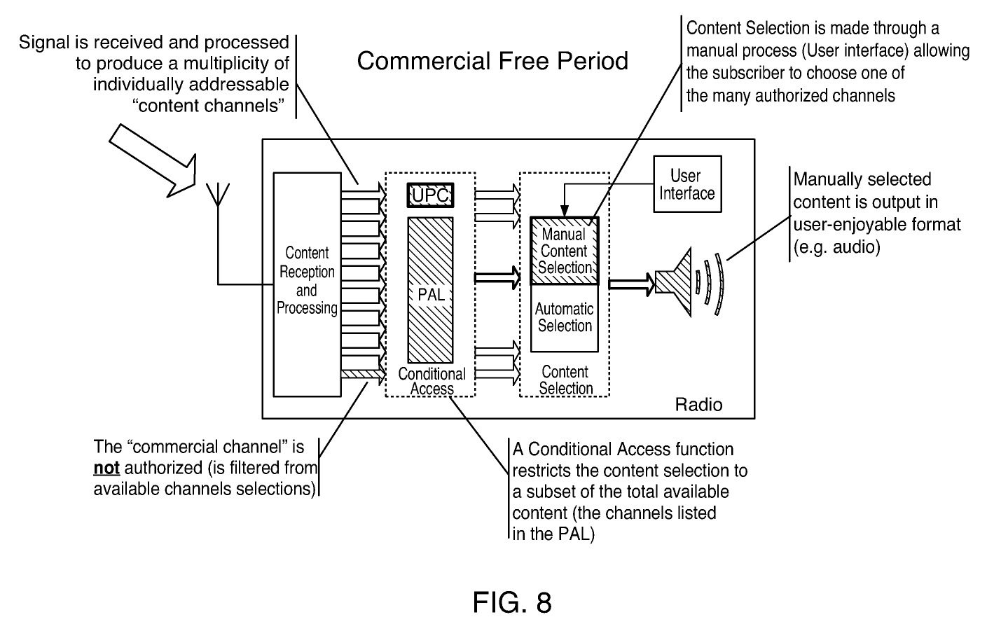

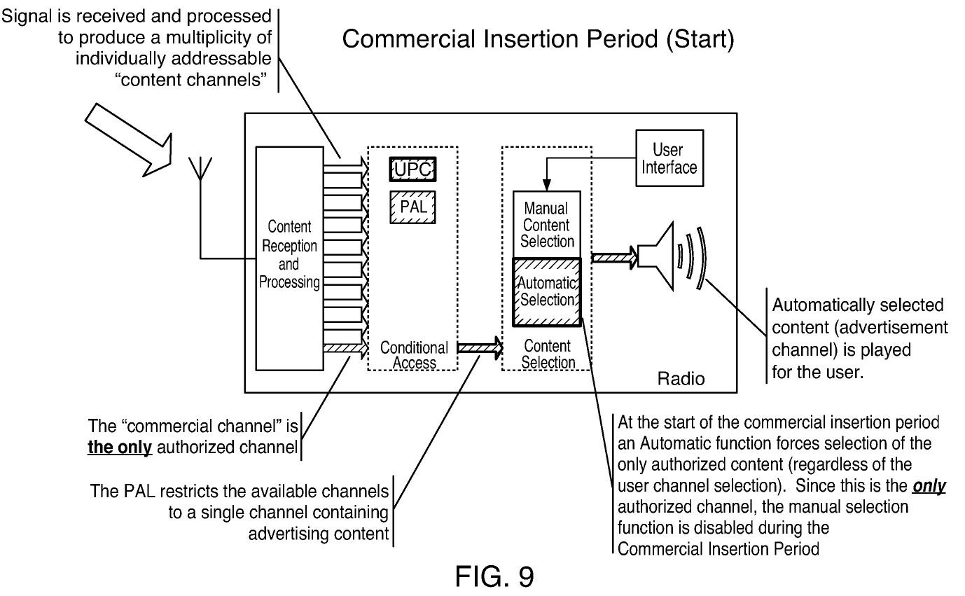

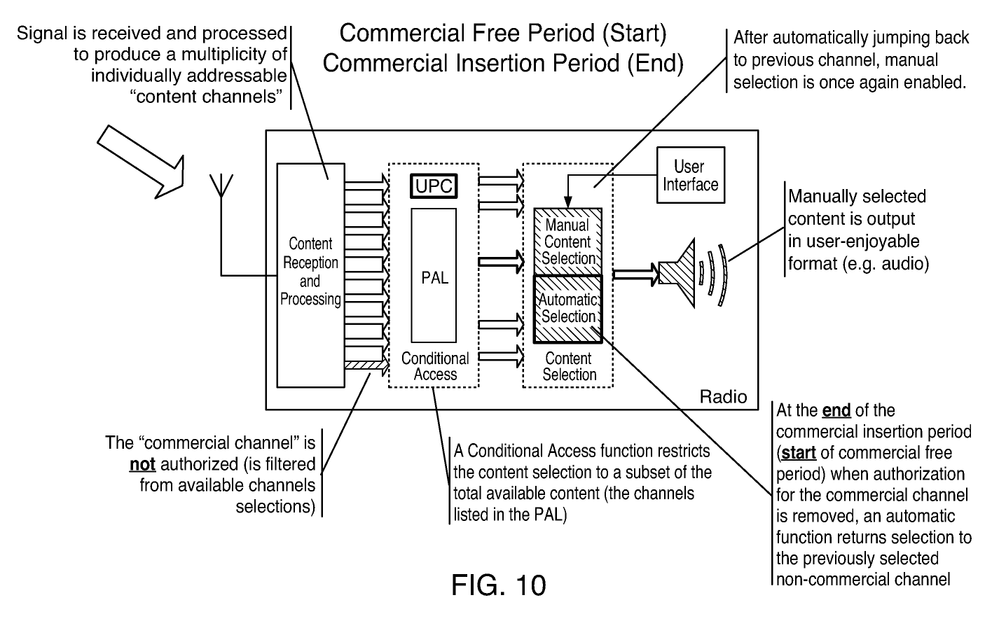

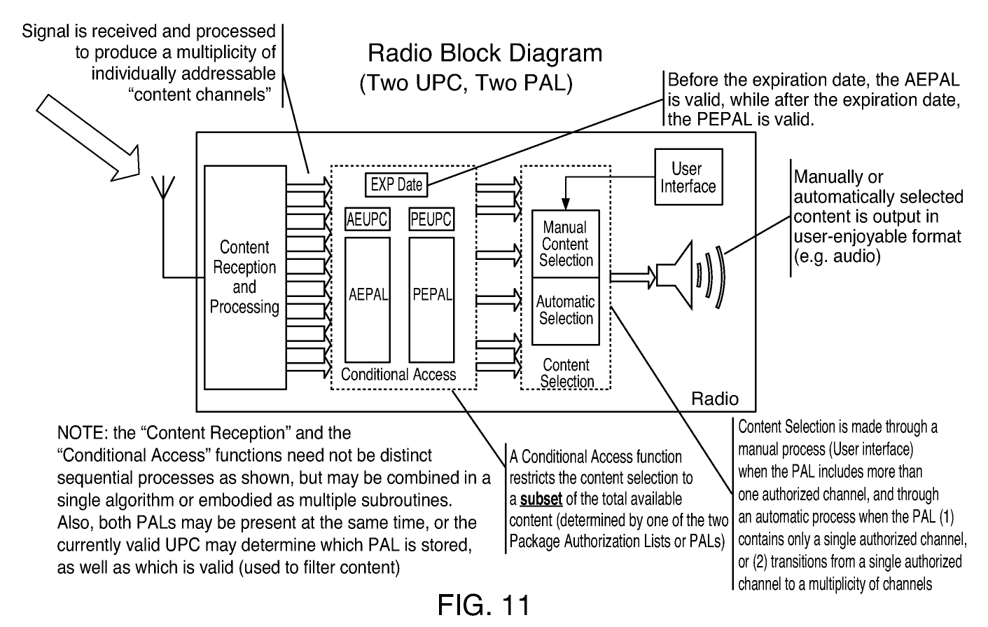

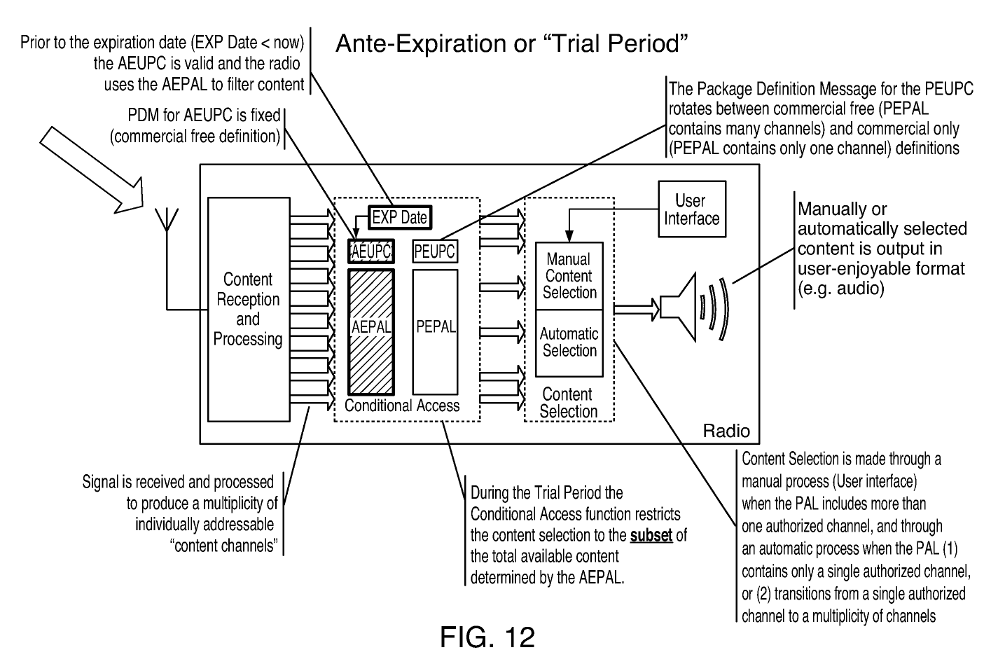

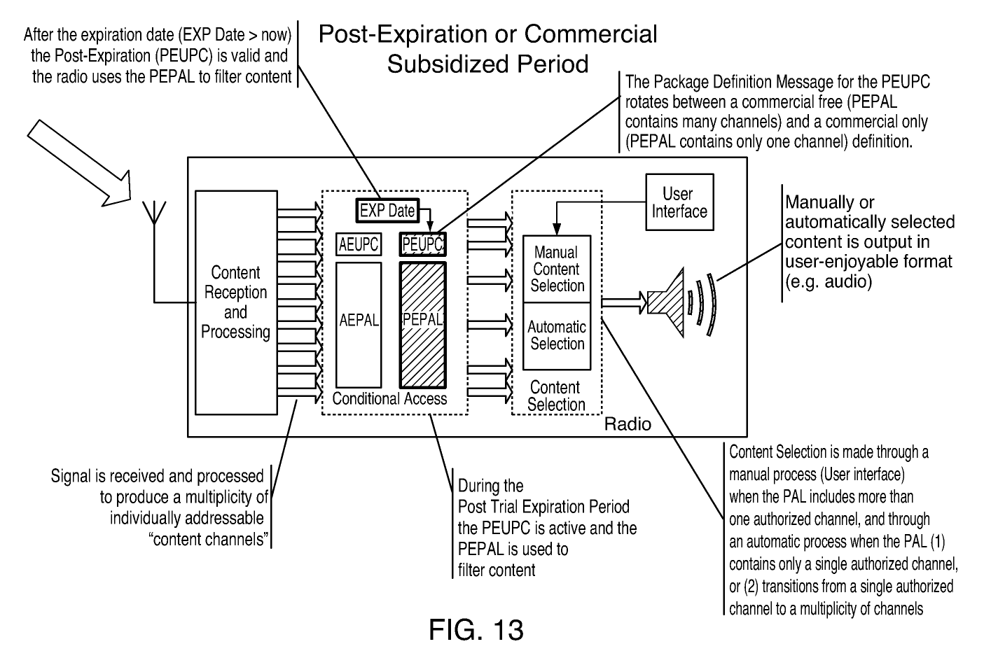

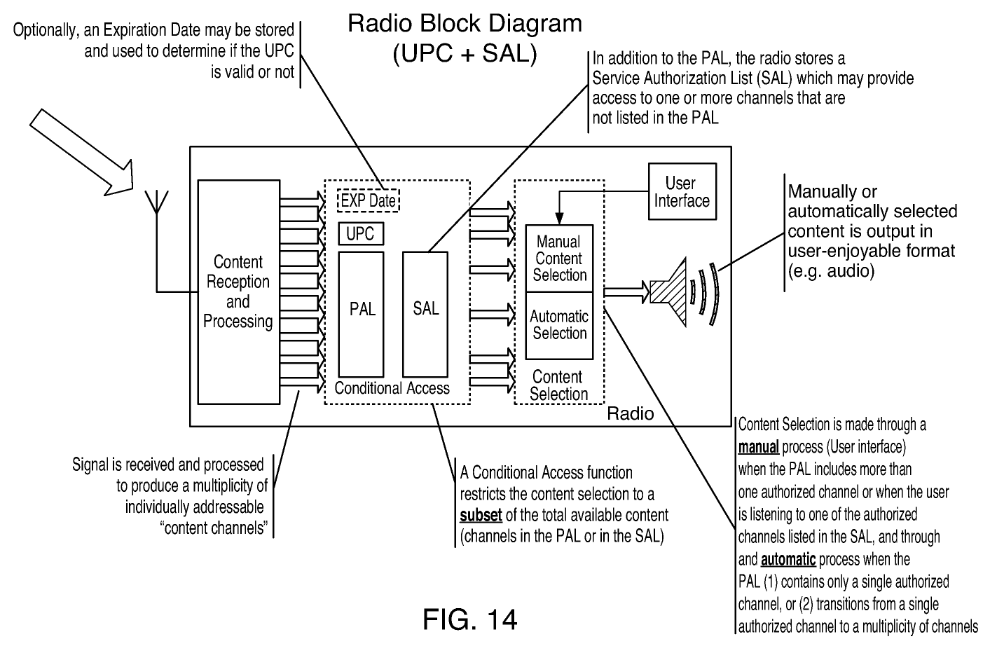

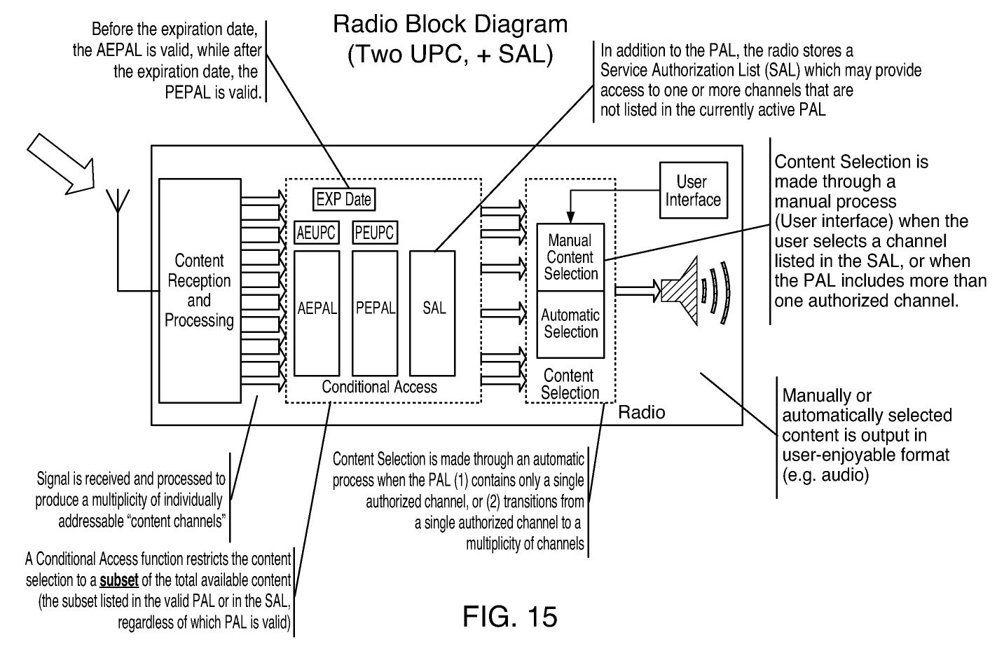

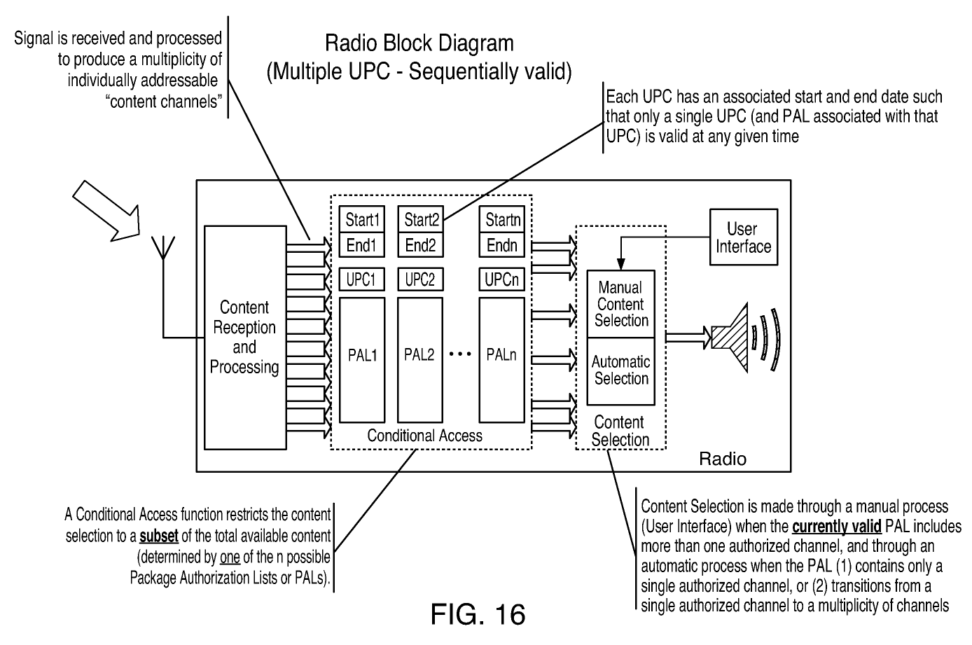

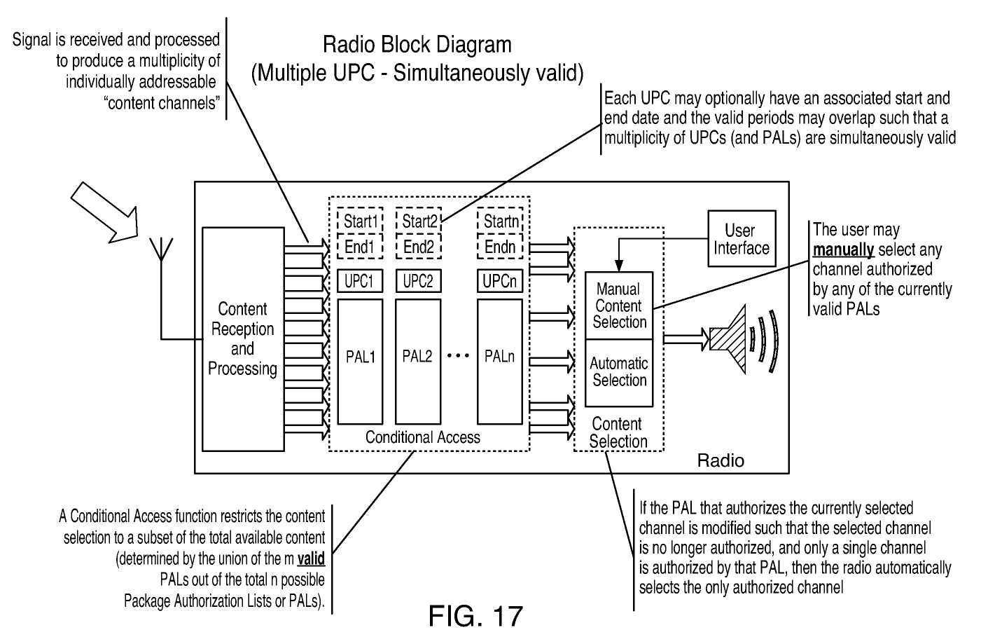

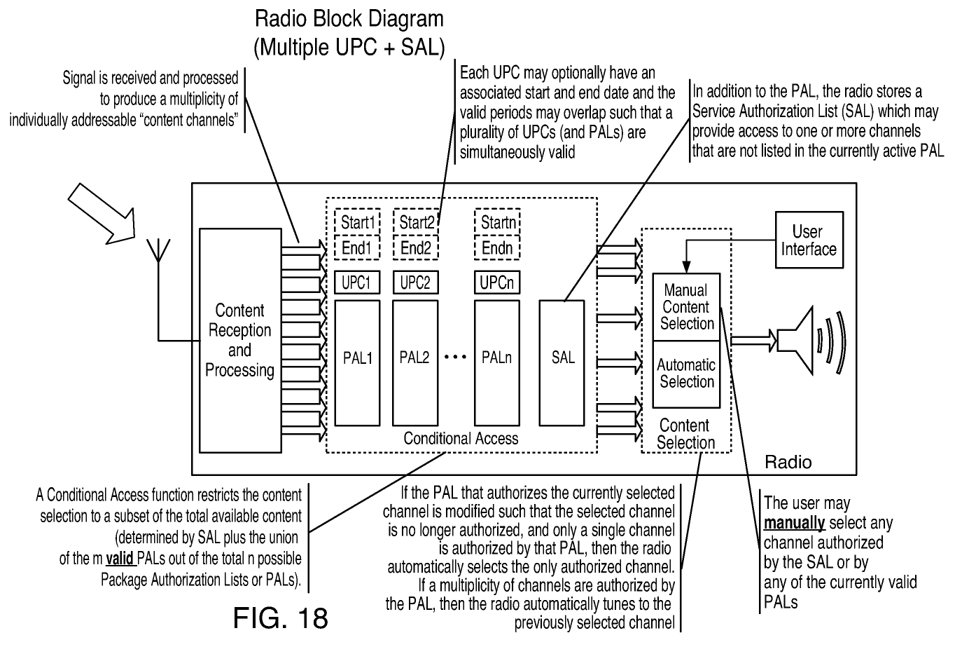

FIGS. 7-18 illustrate in detail various aspects of exemplary use cases according to various exemplary embodiments of the present invention, as described above, and various combinations thereof.

Although the present invention has been described in relation to particular embodiments thereof, many other variations and modifications and other uses will become apparent to those skilled in the art. For example, those skilled in the art can readily appreciate how the techniques of the disclosed invention can be adapted in myriads of ways to flexibly control subscriber access to programming. There are innumerable ways in which various combinations of UPC(s), PALs, SALs, PDMs and rotating PDMs can be combined to craft digital radio subscriber custom packages and marketing strategies, all without any requirement for the broadcast system to individually address a given specific radio. Thus, the present invention is not to be limited by the specific disclosure herein, but rather only by the appended claims.

What is claimed:

1. A method of channel authorization for digital audio radios, comprising:
assigning and storing at least one Uplink Package Code (UPC) in a digital audio radio; and
receiving a broadcast Package Definition Message (PDM) that maps the UPC to a list of authorized channels.

2. The method of claim 1, wherein the PDM is broadcast periodically with a modified PDM for a particular UPC.

3. The method of claim 1, wherein the PDM is broadcast to temporarily add additional authorized channels to allow a subscriber to temporarily sample the additional authorized channels until a new PDM is broadcast.

4. The method of claim 1, wherein for a given subset of UPC, the PDM is varied to provide a plurality of authorized channels during a commercial free period and to provide a single authorized channel during a commercial insertion period.

5. The method of claim 4, wherein the given subset of UPCs are subscribers of a lower tier package of service that requires the given subset of UPC to listen to periodic commercials.

6. The method of claim 5, wherein the given subset of UPCs are the subscribers of the lower tier package of service required to listen to period commercial while subscribers without the given subset of UPSC are subscribers of a higher tier package that have commercial free content.

7. The method of claim 1, wherein the assigned and stored UPC comprises a first UPC or Ante-Expiry UPC that is valid for an initial fixed period of time and a second UPC or Post-'Exiry UPC that is valid after the initial fixed period of time.

8. The method of claim 7, wherein the first UPC authorizes a subscriber for a commercial free period during the initial fixed period of time and thereafter automatically moves to a commercially sponsored package after the initial fixed period of time.

9. A digital audio radio, comprising:
a controller, operable to:
receive and store an Uplink Package Code (UPC) in the digital audio radio; and
receive a broadcasted Package Definition Message (PDM) that maps the UPC to a list of authorized channels.

10. The digital audio radio of claim 9, wherein the digital audio radio updates the list of authorized channels if a UPC in the PDM matches the UPC stored in the digital audio radio.

11. The digital audio radio of claim 10, wherein the PDM enables an authorized subset of channels as filtered by the list of authorized channels.

12. The digital audio radio of claim 9, wherein the digital audio radio receives a PDM from an uplink that defines a fixed relationship between the UPC and a list of authorized channels wherein a subscriber selects any one of a plurality of authorized channels during a commercial free period.

13. The digital audio radio of claim 9, wherein the digital audio radio receives a PDM from an uplink that defines a fixed relationship between the UPC and a sponsored package of the list of authorized channels having a single channel wherein all subscribers to the sponsored package listens to the same commercial during a commercial insertion period.

14. The digital audio radio of claim 9, wherein the PDM is broadcast periodically with a modified PDM for a particular UPC.

15. The digital audio radio of claim 9, wherein the PDM is broadcast to temporarily add additional authorized channels to allow a subscriber to temporarily sample the additional authorized channels until a new PDM is broadcast.

16. The digital audio radio of claim 9, wherein for a given subset of UPCs, the PDM is varied to provide a plurality of authorized channels during a commercial free period and to provide a single authorized channel during a commercial insertion period.

17. The digital audio radio of claim 16, wherein the given subset of UPCs are subscribers of a lower tier package of service that requires the given subset of UPC to listen to periodic commercials.

18. The digital audio radio of claim 17, wherein the given subset of UPCs are the subscribers of the lower tier package of service required to listen to period commercial while subscribers without the given subset of UPSC are subscribers of a higher tier package that have commercial free content.

19. The digital audio radio of claim 9, wherein the assigned and stored UPC comprises a first UPC or Ante-Expiry UPC that is valid for an initial fixed period of time and a second UPC or Post-Exiry UPC that is valid after the initial fixed period of time.

20. The digital audio radio of claim 19, wherein the first UPC authorizes a subscriber for a commercial free period during the initial fixed period of time and thereafter automatically moves to a commercially sponsored package after the initial fixed period of time.

21. The digital audio radio of claim 9, wherein the digital audio receiver further comprises a satellite digital audio receiver and a decoder.

22. The method of claim 1 wherein the UPC is assigned to a radio based on the subscriber's affiliation with a particular demographic or self-identified interest group, and the PDM associated with that UPC is varied periodically to first grant authorization to a plurality of channels of interest to that group and then to grant authorization to a single channel containing advertising of interest to that demographic or interest group.

23. The method of claim 4 wherein the UPC is assigned to a radio based on the subscriber's affiliation with a particular demographic or self-identified interest group, and the PDM associated with that UPC is varied periodically to first grant authorization to a plurality of channels of interest to that group and then to grant authorization to a single channel containing advertising of interest to that demographic or interest group.

24. The method of claim 22 wherein instead of restricting authorization to a different channel for each interest group, several interest groups or all interest groups are restricted to a single common channel to aggregate their numbers.

25. The method of claim 1, wherein the method assigns the UPC to the radio during the manufacture of the radio, after the manufacture of the radio at a distribution point of the manufacturer, and at a reseller distribution point later in a supply chain.

26. The method of claim 1, wherein more than one UPC is loaded into the radio when it is manufactured and a subsequent irreversible process later in a supply chain is used to select one of the available UPCs to be active while the others are erased.

27. The method of claim 25, wherein more than one UPC is loaded into the radio when it is manufactured and a subsequent irreversible process later in the supply chain is used to select one of the available UPCs to be active while the others are erased.

28. The method of claim 1, wherein the purchaser of the radio selects a UPC from a radio menu at a time of first radio power-on based on a subscriber's self identification or self indication of radio genre interests among sports, news, comedy, classical music, political, and religious programming, whereupon the other UPCs are then erased.

29. The method of claim 28, wherein the purchaser of the radio selects a UPC from a radio menu at a time of first radio power-on based on a subscriber's self identification or self indication of radio genre interests among sports, news, comedy, classical music, political, and religious programming, whereupon the other UPCs are then erased.

30. The method of claim 1, wherein at a time of authorization the radio receives an explicit list of services in the form of a Service Authorization List (SAL) in addition to the UPC or UPCs assigned to the radio, wherein the SAL gives the radio access to a list of channels in addition to the list authorized by the UPC, such that when the subscriber listens to a channel that is authorized because it is listed in the SAL the subscriber avoids commercials, whereas when the subscriber listens to a channel authorized through the UPC the subscriber is forced to listen to commercials because of a rotating package definition message having the PDM.

31. The method of claim 30, wherein the SAL has an explicit expiration date, leaving the radio only authorized for channels in the list of authorized channels.

32. The method of claim 30 wherein the UPC has an explicit expiration date, while the SAL does not expire, thus allowing access to a large number of commercial sponsored channels for a limited period of time, followed by a permanent ability to receive only the channels provided in the SAL.
